(19) United States
(12) Patent Application Publication
(10) Pub. No.: US 2026/0018971 A1
(43) Pub. Date: Jan. 15, 2026

(54) Integration of Inductive Position Sensor in a Rotary Transformer

(71) Applicants: BorgWarner Inc., Auburn Hills, MI (US); UT-Battelle, LLC, Oak Ridge, TN (US)

(72) Inventors: Gabriel Alejandro Domingues Olavarria, Lund (SE); Fred Huscher, Hendersonville, NC (US); Mostak Mohamamd, Knoxville, TN (US); Shajjad Chowdhury, Knoxville, TN (US); Omer Onar, Farragut, TN (US); Jonathan Wilkins, Knoxville, TN (US); Daniel Wilkins, Fishers, IN (US)

(21) Appl. No.: 19/269,214

(22) Filed: Jul. 15, 2025

Related U.S. Application Data
(60) Provisional application No. 63/671,579, filed on Jul. 15, 2024.

(51) Int. Cl. H02K 11/00; H02K 11/042; H02K 11/225

(52) U.S. Cl. CPC H02K 11/0094; H02K 11/042; H02K 11/225

(57) ABSTRACT

A rotary transformer with an integrated inductive position sensor is disclosed herein. The rotary transformer comprises a stationary side and a rotating side. The stationary side includes a core defining a central axis and a first printed circuit board (PCB) coupled to the core. A primary coil of the rotary transformer is positioned within the core concentric with the central axis. An excitation coil of an inductive position sensor and at least one sensing coil of the inductive position sensor is positioned on the first PCB. The rotating side includes a second PCB with a secondary coil of the rotary transformer positioned on the second PCB. Additionally, at least one target for the inductive position sensor positioned on the second PCB. The rotary transformer may be advantageously used to feed the rotor of a wound rotor synchronous machine.

### CROSS-REFERENCE TO RELATED APPLICATIONS

This application claims priority to U.S. provisional patent application No. 63/671,579, filed Jul. 15, 2024, the entire contents of which are incorporated by reference herein.

### GOVERNMENT LICENSE RIGHTS

This invention was made under CRADA No. NFE-22-09369 between BorgWarner Inc. and UT-Battelle, LLC, management and operating contractor for the Oak Ridge National Laboratory for the United States Department of Energy. The Government has certain rights in this invention.

### FIELD

The present disclosure relates to the field of electric machines, and particularly to rotary transformers used in electric machines.

### BACKGROUND

Wound rotor synchronous machines (WRSMs) are increasingly common in many modern applications, including electric vehicles, wind turbines and industrial motors. WRSMs do not use any permanent magnets (PM) and are great alternatives to permanent magnet based motors for many applications. However, traditional WRSMs have disadvantages because they use brushes and slip rings for power transfer between the stator and the rotor. These brushes and slip rings cause friction, wear, and frequent maintenance.

Polyphase rotary transformers have been utilized in various applications to enable wireless power transfer to the rotor windings of WRSMs. Rotary transformers are particularly advantageous because they eliminate the need for slip rings and brushes. By using a high-frequency, three-phase rotary transformer in WRSMs, the challenges associated with slip rings and brushes are avoided.

The rotary transformer is especially applicable for high-speed and high-frequency applications, such as electric vehicles (EVs). In many applications for WRSMs, there are numerous rotating members that need to be monitored. For example, in vehicles, various rotating members transfer power to the wheels of the vehicle and monitoring of these rotating members is important in order to control functions of the vehicle. Rotary sensors are commonly used in vehicles to monitor these rotating members.

In view of the foregoing, it would be advantageous to provide an arrangement wherein a rotary position sensor could be advantageously used alongside a rotary transformer. It would be particularly advantageous if such a rotary transformer and rotary position sensor offered a compact design with smaller and more efficient components. A compact design would be especially advantageous in motor vehicle applications and related applications with limited space. Moreover, it would be advantageous if the rotary transformer and rotary position sensor were offered in arrangement that resulted in lower manufacturing costs and improved manufacturing efficiencies for the desired application.

### SUMMARY

A system and method is disclosed herein for the integration of an inductive position sensor in a rotary transformer. The rotary transformer may be used to feed the rotor of a wound rotor synchronous machine (WRSM). The disclosed integration concept uses a PCB on the rotating side of the rotary transformer as target for the inductive position sensor.

In at least one embodiment, a rotary transformer comprises a stationary side and a rotating side. The stationary side includes a core defining a central axis and a first printed circuit board (PCB) coupled to the core. A primary coil of the rotary transformer is positioned within the core and is concentric with the central axis. An excitation coil of an inductive position sensor and at least one sensing coil of the inductive position sensor is positioned adjacent to the core on the first PCB. The rotating side includes a second PCB with a secondary coil of the rotary transformer positioned on the second PCB. Additionally, at least one target for the inductive position sensor positioned on the second PCB.

In at least one embodiment, a rotary transformer comprises a stationary side positioned across an airgap from a rotating side. The stationary side includes a stationary mount which may be provided by a core and a stationary printed circuit board. A primary coil of the rotary transformer, an excitation coil of an inductive position sensor, and at least one sensing coil of the inductive position sensor are arranged on the stationary mount. The rotating side includes a rotating monolithic mount which may be provided by a printed circuit board. The secondary coil of the rotary transformer and at least one target of the inductive position sensor are arranged on the rotating monolithic mount.

In at least one embodiment the rotary transformer is provided within a wound rotor synchronous machine (WRSM). The WRSM comprises a stator including a stator core with stator windings positioned on the stator core, and a rotor including a rotor core with rotor windings positioned on the rotor core. The rotary transformer comprises a stationary side and a rotating side. The stationary side includes a primary coil, an excitation coil of an inductive position sensor, and a sensing coil of the inductive position sensor. The rotating side includes a rotating monolithic mount with a secondary coil of the rotary transformer and at least one target of the inductive position sensor arranged on the rotating monolithic mount.

The above described features and advantages, as well as others, will become more readily apparent to those of ordinary skill in the art by reference to the following detailed description and accompanying drawings. While it would be desirable to provide a method and system for integration of an inductive position sensor in a rotary transformer, including a system that provides one or more of these or other advantageous features as may be apparent to those reviewing this disclosure, the teachings disclosed herein extend to those embodiments which fall within the scope of any eventually appended claims, regardless of whether they include or accomplish one or more of the advantages or features mentioned herein.

### BRIEF DESCRIPTION OF THE DRAWINGS

FIG. 1A shows a face view of a stationary side of a first rotary transformer arrangement, the stationary side including an inner Litz wire primary coil of a transformer and outer excitation and sensing coils of an inductive position sensor;

FIG. 1B shows a side cutaway view of the stationary side of the rotary transformer arrangement of FIG. 1A;

FIG. 1C shows a face view of a rotating side of the rotary transformer arrangement of FIG. 1A, the rotating side including an inner secondary coil of a transformer and outer target pads for the inductive position sensor;

FIG. 1D shows a side cutaway view of the rotating side of the rotary transformer arrangement of FIG. 1C;

FIG. 1E shows a side cutaway view of the stationary side of the rotary transformer arrangement of FIG. 1A across a small airgap from the rotating side of the rotary transformer arrangement;

FIG. 2A shows a face view of a stationary side of a second rotary transformer arrangement, the stationary side including an inner PCB primary coil of a transformer and outer excitation and sensing coils of an inductive position sensor;

FIG. 2B shows a side view of the stationary side of the rotary transformer arrangement of FIG. 2A;

FIG. 2C shows a face view of a rotating side of the rotary transformer arrangement of FIG. 2A, the rotating side including an inner secondary coil of a transformer and outer target pads for the inductive position sensor;

FIG. 2D shows a side view of the rotating side of the rotary transformer arrangement of FIG. 2C;

FIG. 3A shows a face view of a stationary side of a third rotary transformer arrangement, the stationary side including an outer Litz wire primary coil of a transformer and inner excitation and sensing coils of an inductive position sensor;

FIG. 3B shows a side view of the stationary side of the rotary transformer arrangement of FIG. 3A;

FIG. 3C shows a face view of a rotating side of the rotary transformer arrangement of FIG. 3A, the rotating side including an outer secondary coil of a transformer and inner target pads for the inductive position sensor;

FIG. 3D shows a side view of the rotating side of the rotary transformer arrangement of FIG. 3C;

FIG. 4A shows a face view of a stationary side of a fourth rotary transformer arrangement, the stationary side including an outer PCB wire primary coil of a transformer and inner excitation and sensing coils of an inductive position sensor;

FIG. 4B shows a side view of the stationary side of the rotary transformer arrangement of FIG. 4A;

FIG. 4C shows a face view of a rotating side of the rotary transformer arrangement of FIG. 4A, the rotating side including an outer secondary coil of a transformer and inner target pads for the inductive position sensor;

FIG. 4D shows a side view of the rotating side of the rotary transformer arrangement of FIG. 4C; and

FIG. 5 shows a schematic arrangement of the rotary transformer arrangement with the integrated rotary position sensor of FIG. 1E integrated into a wound rotor synchronous machine.

### DESCRIPTION

A rotary transformer is disclosed herein including a stationary portion and a rotary portion. The stationary portion of the rotary transformer includes a core with a primary side coil arranged within the core. The stationary portion further includes sensor coils for an inductive rotary position sensor arranged radially inward or radially outward from the primary side coil. The rotating portion of the rotary transformer includes a secondary side coil positioned opposite the primary side coil. Targets for the inductive rotary position sensor are positioned opposite the sensor coils and arranged either radially inward or radially outward from the secondary side coil.

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Additionally, it will be noted that the following description of embodiments of the rotary transformer makes use of relative terms that may be dependent on an orientation of the structure at a given time (e.g., during manufacture or use of the machine in a vehicle). Accordingly, it will be recognized that many terms of orientation and position as used herein are defined with reference to what may be shown in the drawing and/or other common positions. While efforts have been made herein to reference portions of the structure with respect to non-changing features (e.g., “axial,” “radial” and “circumferential” directions and related positions of the stator), it will be recognized that other terms are relative terms that depend on the position of the structure.

### First Embodiment of Rotary Transformer with Integrated Rotary Position Sensor

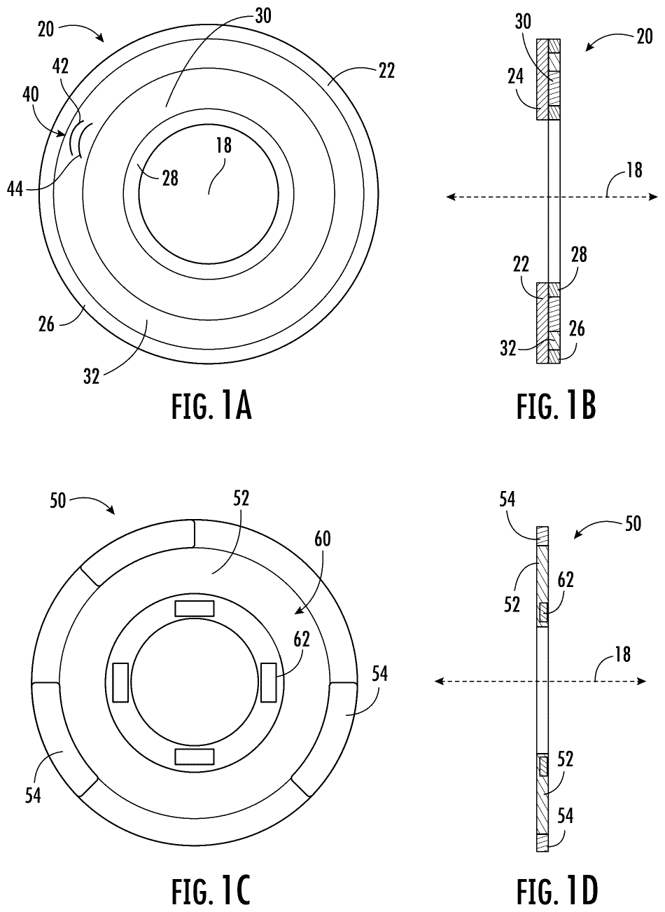

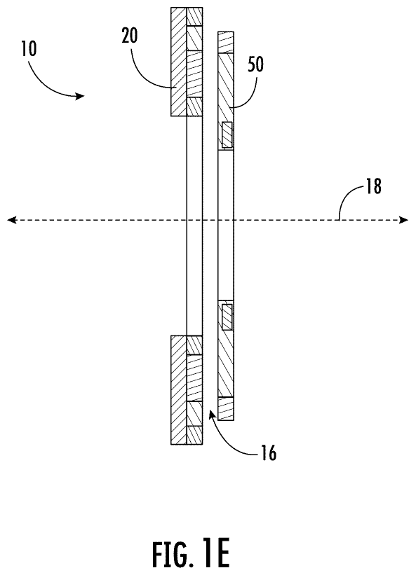

With reference to FIGS. 1A-1E, a first embodiment of a rotary transformer 10 is shown. The rotary transformer 10 includes a stationary side 20 with a primary coil 30 and a rotating side 50 with a secondary coil 60. An inductive rotary position sensor 40 is also included on the rotary transformer 10. The inductive rotary position sensor 40 includes sensor coils 42, 44 on the stationary side 20 and at least one target 54 on the rotating side 50.

With particular reference now to FIGS. 1A and 1B, the stationary side 20 of the rotary transformer 10 includes a core 22, a primary coil 30, a stationary printed circuit board 32, and coils of the rotary position sensor 40. The core 22 is comprised of ferrite or other magnetic-permeable material. The core 22 has a generally circular/cylindrical shape that defines a central axis 18. The core includes a disc-shaped face 24, a circular outer rim 26 and a circular inner lip 28. The face 24 is on one axial side of the core 22 and the rim 26 and lip 28 are on an opposite axial side of the core. A circular cavity is formed in the core 22 between the rim 26 and the lip 28.

The primary coil 30 is positioned within the circular cavity defined by the core 22. In the embodiment of FIGS. 1A-1B, the primary coil 30 is arranged in a radially inward position, closer to the inner lip 28 of the core 22 than the outer rim 26 of the core 22. The primary coil 30 is comprised of a plurality of turns of wire or other conductors wound in a circular manner around the inner lip 28, concentric with the central axis 18. In the embodiment of FIGS. 1A-1B, the wire used to form the primary coil 30 may be Litz wire. As will be recognized by those of ordinary skill in the art, Litz wire includes a number of individually insulated magnet wires twisted or braided into a uniform pattern. Litz wire may be used to advantageously reduce field resistance and allows electric currents to flow more freely within the primary coil.

The stationary printed circuit board 32 (PCB) is also positioned within the circular cavity defined by the core 22. In the embodiment of FIGS. 1A-1B, the stationary PCB is arranged radially outward from the primary coil 30, closer to the outer rim 26. Together the stationary PCB 32 and the core 22 provide a mount for the components on the stationary side 20 of the rotary transformer 10. The stationary PCB 32 is comprised of a non-conductive substrate with a plurality of conductive pathways formed thereon, as will be recognized by those of ordinary skill in the art. The substrate may be any of a number of different materials that are relatively lightweight and durable while also providing mechanical support and electrical insulation. For example, in at least some embodiments the stationary PCB may be comprised of a fiberglass. The conductive pathways on the PCB may be formed from copper or any other appropriate conductive material.

The coils of the inductive rotary position sensor 40 are positioned on the stationary PCB 32 adjacent to the core. These coils include an excitation coil 42 and at least one adjacent sensing coil 44 (and typically two sensing coils 44). The coils 42 and 44 are specifically configured as conductive traces on the PCB 32. These conductive traces are illustrated in the figures by short curve segments for the sake of simplicity, but it will be noted that the conductive traces formed on the stationary PCB 32 actually form complete coils for the rotary position sensor 40, including the complete excitation coil 42 and the complete sensing coils 44. As will be recognized by those of ordinary skill in the art, the excitation coil 42 of the inductive rotary sensor 40 is used to generate an AC magnetic field (and may also be referred to as a “transmitter coil”). This magnetic field couples onto the sensing coils 44. When a target of the sensor disturbs the generated magnetic field, the sensing coils 44 receive different voltages. The different voltages received by the sensing coils 44 may be used to determine a position of a rotating member upon which the target is placed (e.g., the rotating side 50 of the rotary transformer 10). In at least one embodiment a ratio of a voltages between a first sensing coil and a second sensing coil is used to determine an angular position of the target on rotating side 50 of the rotary transformer 10.

With reference now to FIGS. 1C-1E, a rotating side 50 of the rotary transformer 10 is shown. The rotating side 50 of the rotary transformer 10 is centered about the central axis 18 and is coaxial with the stationary side 20. The rotating side 50 of the rotary transformer 10 is spaced apart from the stationary side 20 by a small airgap 16 as shown in FIG. 1E.

As best shown in FIGS. 1C and 1D, the rotating side 50 of the rotary transformer 10 includes a rotating PCB 52, a plurality of targets 54, a secondary coil 60, and a plurality of diodes 62 that provide a diode rectifier. It will be recognized that the term “rotating” as used herein refers to a component that is configured to rotate when the rotary transformer 10 is in use. The word “rotating” does not refer to a component that is presently rotating and/or must be experiencing rotational movement in order for the component to be considered a “rotating” component. For example, the PCB 52 is still considered to be a “rotating PCB” by virtue of being configured to rotate when the rotary transformer is in use, and remains a “rotating PCB” when the rotary transformer is not in use and the PCB 52 is not rotating.

The rotating PCB 52 provides a monolithic mount for the components on the rotating side 50 of the rotary transformer 10. The rotating PCB is comprised of a non-conductive substrate with a plurality of conductive pathways formed thereon. Similar to the stationary PCB 32, the substrate of the rotating PCB may be any of a number of different materials that are relatively lightweight and durable while also providing mechanical support and electrical insulation. The conductive pathways on the PCB 52 may be formed from copper or any other appropriate conductive material.

A plurality of target pads 54 for the inductive rotary position sensor 40 are positioned on (or arranged proximate to) the rotating PCB 52. The plurality of target pads 54 (which may also be referred to herein as simply “targets”) are positioned axially opposite the coils 42, 44 of the rotary position sensor 40. Together, the targets 54 on the rotating side and the coils 42, 44 on the stationary side provide the rotary position sensor 40. In the embodiments disclosed herein, each of the plurality of targets 54 is comprised of a solid piece of metal material, typically a ferrous metal. Each target 54 is positioned on or is otherwise coupled to the rotating PCB 52. Each target 54 also has the shape of a disc segment wherein each disc segment spans along an arc of equal length. For example, in at least some embodiments each target 54 spans along an arc of 15°-45°. In the embodiment of FIGS. 1C-1D, three targets are provided with each target 54 spanning an arc of 30°. In this embodiment, the targets 54 are arranged in recesses formed along the radially outer perimeter of the PCB 52. In this manner, the material that forms the PCB 52 is used to support each target without requiring additional axial depth on the rotating side (i.e., as would be required if the targets 54 were placed directly on the PCB 52).

The secondary coil 60 of the rotary transformer 10 is positioned on the rotating PCB 52, radially inward from the targets 54. The secondary coil 60 is comprised of a plurality of turns of conductive traces on the PCB 52 that are arranged a circular manner around the central axis 18. In the embodiment of FIGS. 1C-1D, the secondary coil 60 is arranged in a radially inward position directly across from the primary coil 30 on the stationary side of the rotary transformer 10. The secondary coil 60 is further connected to the diodes 62 of the diode rectifier. During operation of the transformer, a magnetic field from the primary coil 30 links with the secondary coil 60 and induces an alternating current in the secondary coil 60. The alternating current induced in the secondary coil 60 is rectified using the diode rectifier.

The diode rectifier includes a plurality of diodes 62 connected together to form a diode bridge that rectifies the alternating current in the secondary coil into direct current (e.g., for delivery to rotor coils of a WRSM), as will be recognized by those of ordinary skill in the art. In the embodiment of FIGS. 1C-1D, the diode rectifier includes four diodes 62 equally spaced on a radially inner portion of the rotating PCB 52 (e.g., each diode is positioned 45° offset on the PCB relative to its neighbor diodes). In some embodiments, the diodes 62 may be arranged on a surface of the PCB 52. In other embodiments, the diodes 62 may be embedded in recesses formed in the PCB 52.

In view of the foregoing, it will be recognized that the rotary transformer 10 and integrated rotary position sensor 40 is provided by a stationary side 20 in combination with a rotating side 50. The stationary side 20 includes a single PCB configured to retain at least the excitation coil 42 and sensing coils 44 of the rotary position sensor with the primary coil 30 of the rotary transformer also on the stationary side 20 and contained within a core 22. The rotating side 50 of the rotary transformer is provided by a single PCB construction, in which the target pads 54 for the position sensor 40 are placed at or near the outer perimeter portion of the PCB (which may also be referred to as the “outer diameter” of the PCB), the secondary coils 60 of the rotary transformer 10 are provided by electrically conductive traces arranged on a middle portion of the PCB, and the diodes 62 for the rectifier are arranged at or near an inner perimeter portion of the PCB. With this construction in mind, it will also be recognized that numerous other alternative embodiments of the rotary transformer are possible and contemplated herein.

### Second Embodiment of Rotary Transformer with Integrated Rotary Position Sensor

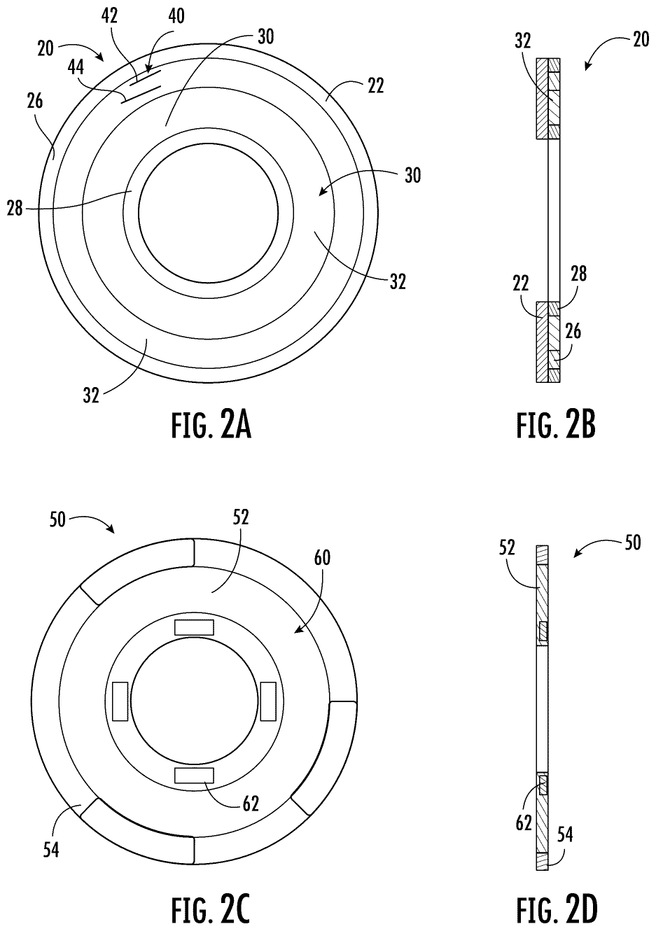

With reference to FIGS. 2A-2D, a second embodiment of the rotary transformer 10 is disclosed. In this second embodiment, the stationary portion of the system (i.e., the stationary side 20 shown in FIGS. 2A and 2B) includes a ferrite core 22 that is the same construction as that shown in the embodiment of FIGS. 1A-1B. However, in the embodiment of FIGS. 2A-2B, a single PCB construction is utilized wherein the stationary PCB 32 that fills the entire cavity in the core 22 between the outer rim 26 and the inner lip 28. The primary coil 30 for the rotary transformer 10 is provided by conductive traces formed on in the inner diameter of the stationary PCB 32 (i.e., closer to the inner lip 28). The excitation coils 42 and sensing coils 44 for the position sensor 40 are arranged on the outer diameter of the stationary PCB 32 (i.e., closer to the outer rim 26).

The rotating portion of the system in the second embodiment of the rotary transformer (i.e., the rotating side 50 shown in FIGS. 2C and 2D) is realized on a single PCB construction provided by the rotating PCB 52. The target pads 54 for the position sensor 40 are arranged on the radial outer diameter of the rotating PCB 52. Such target pads 54 may be positioned on the surface of the PCB 52, embedded in the PCB 52, or otherwise coupled to the rotating PCB 52. The secondary coil 60 for the rotary transformer 10 is provided by conductive traces that are formed in a middle portion of the rotating PCB. Diodes 62 for the rectifier are arranged on the radial inner diameter of the rotating PCB 52. Similar to the target pads 54, the diodes may be positioned on the surface of the PCB 52, embedded in the PCB 52, or otherwise coupled to the rotating PCB 52.

### Third Embodiment of Rotary Transformer with Integrated Rotary Position Sensor

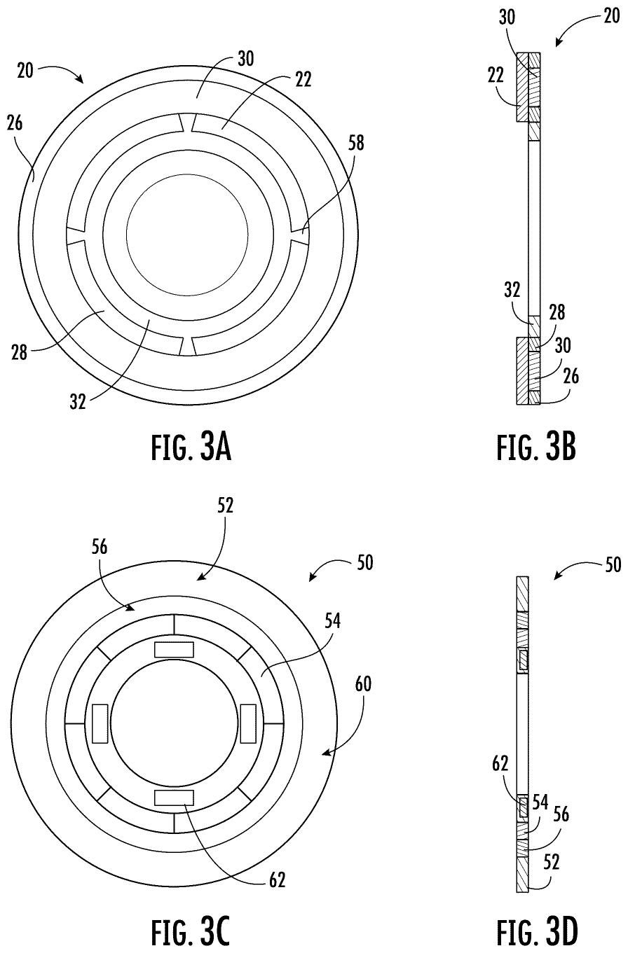

With reference to FIGS. 3A-3D, a third embodiment of the rotary transformer 10 is disclosed. In this third embodiment, the stationary portion of the system (i.e., the stationary side 20 shown in FIGS. 3A and 3B) comprises of a ferrite core 22 encapsulating the primary coil 30 of the rotating transformer 10 with the coils of the position sensor 40 arranged on a stationary PCB 32 that is radially inward from the primary coil 30. Similar to the embodiment of FIGS. 1A-1B, the core 22 includes an outer rim 26 and an inner lip 28. However, the inner lip 28 is moved radially outward from the inner lip relative to the embodiment of FIGS. 1A-1B such that the entire core 22 is situated on the radially outer portion of the stationary side 20 in the embodiment of FIGS. 3A and 3B. This allows the primary coil 30 to fill the cavity in the core formed between the outer rim 26 and the inner lip 28. The primary coil 30 is made out of Litz wire. The PCB 32 for the position sensor 40 is concentric with the core 22 and arranged radially inward from the core 22. Again, the excitation coil 42 and sensing coils 44 for the position sensor 40 are provided by conductive traces on the stationary PCB 32. Furthermore, it will be recognized from FIGS. 3A and 3B that the inner lip may be split into a plurality of sections (e.g., four sections as shown in FIGS. 3A and 3B). The spaces between these sections may be used to assist in coupling the PCB 32 to the core 22 without the need to add axial length to the stationary side 20. For example, these spaces may receive small spokes 58 that extend outwardly from the PCB 32.

The rotating portion of the system (i.e., the stationary side 20 shown in FIGS. 3C and 3D) is realized on a single PCB construction provided by the rotating PCB 52. The secondary coil 60 of the rotary transformer 10 is arranged on the radially outer diameter of the PCB 52. Radially inward from the secondary coil 60 (i.e., in a middle portion 56 of the PCB 52), the PCB 52 is left empty, without any coil traced thereon. This empty middle portion 56 of the PCB is designed to reduce AC losses associated with the fringing flux from the transformer airgap. Targets 54 are arranged radially inward from this empty middle portion 56 on the PCB 52. Additionally, the diodes 62 for the rectifier are arranged on inner diameter of the PCB 52, radially inward from the targets 54.

### Fourth Embodiment of Rotary Transformer with Integrated Rotary Position Sensor

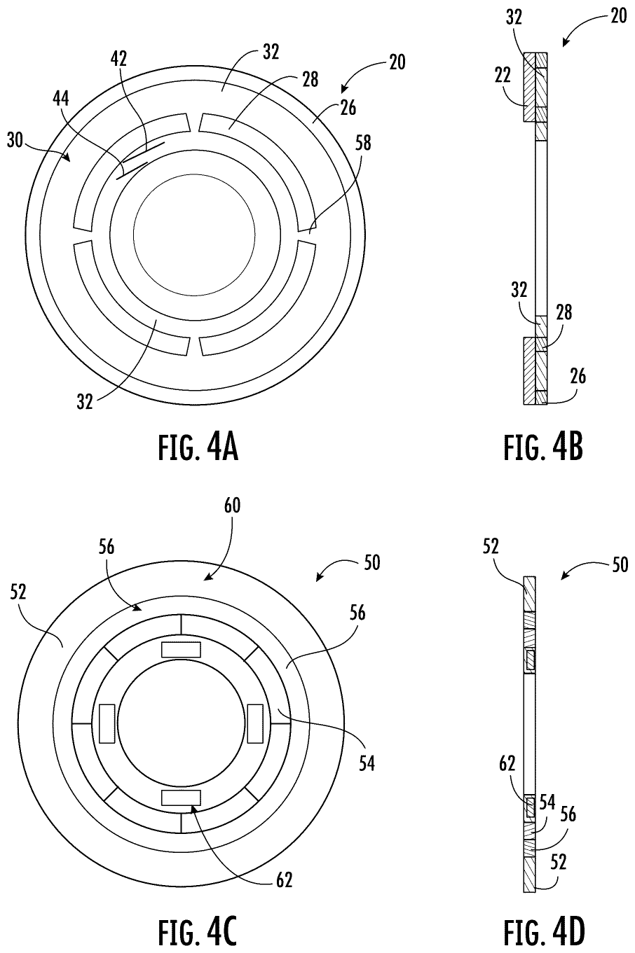

With reference to FIGS. 4A-4D, a fourth embodiment of a rotary transformer is disclosed. In this fourth embodiment, the stationary portion of the system (i.e., the stationary side 20 shown in FIGS. 4A and 4B) comprises of a ferrite core 22 encapsulating an outer part of a single PCB 32 that contains the primary coil 30 and the sensing coils of the rotary position sensor 40. The ferrite core 22 is similar to that shown in the embodiment of FIGS. 3A and 3B. However, in the embodiment of FIGS. 4A and 4B, the stationary PCB 32 includes a radially outer portion retained within the cavity defined by the core 22 and a radially inner portion arranged inside of the inner lip 28 of the core 22. Small connecting spokes 58 extend between segments of the inner lip 28 and connect the radially inner portion of the PCB 32 to the radially outer portion of the PCB 32. The primary coil 30 is provided by conductive traces formed on the outer portion of the PCB 32. The rotary position coils 42, 44 are formed on the radially inner portion of the PCB 32.

The rotating portion of the system (i.e., the rotating side 50 shown in FIGS. 4C and 4D) is again realized on a single PCB construction provided by the rotating PCB 52. The secondary coil 60 of the rotary transformer 10 is arranged on the radially outer diameter of the PCB 52. Radially inward from the secondary coil 60 (i.e., in a middle portion 56 of the PCB 52), the PCB 52 is left empty, void of any coil traced thereon. Again, this empty middle portion 56 of the PCB is designed to reduce AC losses associated with the fringing flux from the transformer airgap. Targets 54 are arranged radially inward from this empty middle portion 56 on the PCB 52. Additionally, the diodes 62 for the rectifier are arranged on the inner diameter of the PCB 52, radially inward from the targets 54.

Electric Machine Including Rotary Transformer with Integrated Rotary Position Sensor

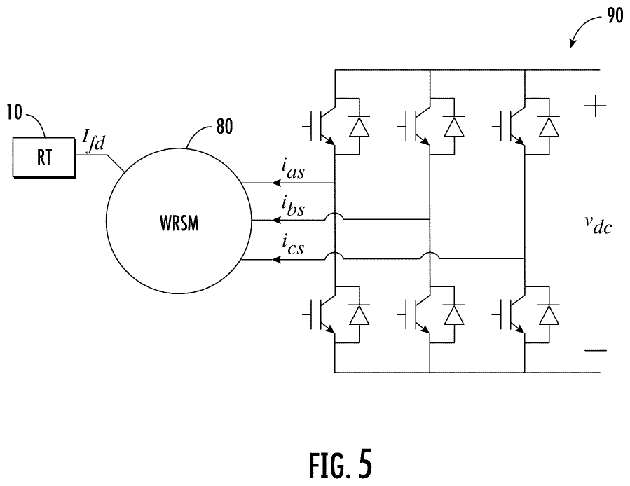

In at least some applications, embodiments of the rotary transformer disclosed herein are used in association with electric machines, such as a WRSM of an electric vehicle. An example of such an arrangement wherein the rotary transformer is used in association with a WRSM is illustrated in FIG. 5. The WRSM 80 includes a stator with armature windings and a rotor with field windings, as will be recognized by those of ordinary skill in the art. The stator windings are configured to receive three phase alternating current from an electrical power source Vdc. For example, in a motor vehicle application, the electrical power source is a vehicle battery The electrical power source is connected to an inverter 90 which converts DC power from the battery to three phase alternating current (iₐₛ, i_{bs}, i_{cs} in FIG. 5) flowing through the windings of the stator. This three phase current is also delivered to the primary coil 30 of the rotary transformer 10. The alternating current in the primary coil 30 of the rotary transformer results in a constantly changing magnetic field around the primary coil 30. This magnetic field then links with the secondary coil 60, inducing an alternating current in the secondary coil 60. The alternating current in the secondary coil 60 is rectified via diodes 62 of the rectifier and delivered as direct current (I_{fd} in FIG. 5) to the field windings of the rotor. The field windings establish magnetic poles on the rotor that then follow the alternating current in the armature windings, causing the rotor to rotate during operation of the WRSM 80.

During operation of the WRSM 80, the inductive rotary sensor 40 integrated into the rotary transformer 10 may be used to sense the position of the rotor (or other rotating components of the electric machine). The inductive position sensor 40 uses the physical principles of induction in a wire loop and Eddy currents to detect the position of the metallic targets 54 that are rotating adjacent the set of sensor coils provided by the transmitter coil 42 and two receiver coils 44. As noted previously, in the embodiments disclosed herein these three coils are printed as copper traces on the stationary printed circuit board 32. They are arranged such that the transmitter coil induces a secondary voltage in the receiver coils which depends on the position of the metallic targets 54 adjacent to the coils 42, 44. After demodulating and processing the secondary voltages from the receiver coils 44, a signal representative of the metallic target's position over the coils is obtained. For example, a ratio of a voltages between two sensing coils 44 may be used to determine an angular position of the target on rotating side 50 of the rotary transformer 10.

Although various embodiments of a rotary transformer have been provided herein, it will be appreciated by those of skill in the art that other implementations and adaptations are possible. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by any eventually appended claims.

What is claimed is:

1. A rotary transformer comprising:
a stationary side including:
a core defining a central axis;
a primary coil of the rotary transformer positioned within the core and concentric with the central axis;
an excitation coil of an inductive position sensor positioned adjacent to the core; and
at least one sensing coil of the inductive position sensor positioned adjacent to the excitation coil; and
a rotating side including:
a secondary coil of the rotary transformer; and
at least one target for the inductive position sensor positioned adjacent to the secondary coil.

2. The rotary transformer of claim 1 wherein the primary coil is arranged radially inward from the excitation coil and the at least one sensing coil.

3. The rotary transformer of claim 1 wherein the primary coil is arranged radially outward from the excitation coil and the at least one sensing coil.

4. The rotary transformer of claim 1 wherein the primary coil is comprised of Litz wire.

5. The rotary transformer of claim 1 wherein the primary coil, the excitation coil, and the at least one sensing coil are positioned on a first printed circuit board (PCB) coupled to the core.

6. The rotary transformer of claim 5 wherein the secondary coil and the at least one target are positioned on a second PCB.

7. The rotary transformer of claim 6 further comprising a diode rectifier positioned on the second PCB.

8. The rotary transformer of claim 7 wherein the diode rectifier is arranged radially inward from the at least one target.

9. The rotary transformer of claim 1 wherein the at least one target includes a plurality of target pads comprised of a ferrous metal material.

10. The rotary transformer of claim 1 wherein the secondary coil is arranged radially inward from the at least one target.

11. The rotary transformer of claim 1 wherein the secondary coil is arranged radially outward from the at least one target.

12. A rotary transformer comprising:
a stationary side including a stationary mount, wherein a primary coil of the rotary transformer, an excitation coil of an inductive position sensor, and at least one sensing coil of the inductive position sensor are arranged on the stationary mount; and
a rotating side including a rotating monolithic mount, wherein a secondary coil of the rotary transformer and at least one target of the inductive position sensor are arranged on the rotating monolithic mount.

13. The rotary transformer of claim 12 wherein the stationary mount includes a core and a first printed circuit board (PCB), and wherein the rotating monolithic mount is a second PCB.

14. The rotary transformer of claim 12 further comprising a diode rectifier arranged radially inward from the at least one target on the rotating monolithic mount.

15. The rotary transformer of claim 12 wherein the primary coil is arranged radially inward from the excitation coil and the at least one sensing coil on the stationary mount, and wherein the secondary coil is arranged radially inward from the at least one target on the rotating monolithic mount.

16. The rotary transformer of claim 12 wherein the primary coil is arranged radially outward from the excitation coil and the at least one sensing coil on the stationary mount, and wherein the secondary coil is arranged radially outward from the at least one target on the rotating monolithic mount.

17. A wound rotor synchronous machine (WRSM) comprising:
a stator including a stator core with stator windings positioned on the stator core;
a rotor including a rotor core with rotor windings positioned on the rotor core; and
a rotary transformer comprising:
a stationary side including a primary coil, an excitation coil of an inductive position sensor, and a sensing coil of the inductive position sensor; and
a rotating side including a rotating monolithic mount with a secondary coil of the rotary transformer and at least one target of the inductive position sensor arranged on the rotating monolithic mount.

18. The wound rotor synchronous machine of claim 17 wherein the stationary side further includes a core defining a cavity, wherein the primary coil is positioned within the cavity.

19. The wound rotor synchronous machine of claim 18 wherein the stationary side further includes a stationary printed circuit board wherein the primary coil, the excitation coil, and the sensing coil are all arranged on the stationary printed circuit board, and wherein the excitation coil and the sensing coil are arranged outside of the cavity defined by the core.

20. The wound rotor synchronous machine of claim 17 wherein the rotating monolithic mount is a rotating printed circuit board.
